(19) United States
(12) Patent Application Publication
(10) Pub. No.: US 2008/0125539 A1
(43) Pub. Date: May 29, 2008

(54) Humidity-Hardening Binding Agent

(75) Inventor: Helmut Mack, Traunstein (DE)

Correspondence Address: FULBRIGHT & JAWORSKI, LLP, 666 FIFTH AVE, NEW YORK, NY, 10103-3198, US

(73) Assignee: CONSTRUCTION RESEARCH & TECHNOLOGY GMBH, Trostberg (DE)

(21) Appl. No.: 11/666,597

(22) PCT Filed: Nov. 15, 2005
(86) PCT No.: PCT/EP05/12258

§ 371 Date: Apr. 27, 2007

(30) Foreign Application Priority Data
Nov. 17, 2004 (DE) 10 2004 055 450.1

(51) Int. Cl. C08G 77/12

(52) U.S. Cl. 524/588; 528/31

(57) ABSTRACT

Moisture-curing binder comprising
a) a silane-modified polyurethane and
b) a silane-modified acrylate polymer,
   with the binder being able to cure in the presence of moisture.

### FIELD OF THE INVENTION

The present invention relates to a moisture-curing binder based on polyurethane, in particular for industrial and building applications. The invention further relates to a kit comprising two components for producing the moisture-curing binder, a method of producing the moisture-curing binder and a moisture-cured binder produced from the moisture-curing binder.

### BACKGROUND OF THE INVENTION

Silane-terminated polyurethanes which have at least one reactive silane group (these silane groups can contain either a hydroxyl group or a hydrolysable group such as alkoxy, acetoxy, oxime, benzamide or a chlorine atom bound to silicon), preferably two or three reactive silane groups, and can be crosslinked at room temperature have been used for a long time for producing adhesives and sealants and further industrial and building products such as levelling compositions, floor coverings, paints and varnishes, potting compositions, building foams, etc. Products having a good property profile while keeping within a sensible commercial frame can be formulated therewith. In building and construction, joints serve to accommodate movement between individual structural elements which is caused, for example, by thermal expansion or settling processes. In general, sealants, for example in accordance with DIN EN ISO 11600, are used for closing the joints.

Silane-modified polyether urethanes having reactive silane groups and their use in adhesives and sealants are known and described in, inter alia, U.S. Pat. No. 5,554,709, U.S. Pat. No. 4,857,623, U.S. Pat. No. 5,227,434, U.S. Pat. No. 6,197,912, U.S. Pat. No. 6,498,210 and U.S. Pat. No. 4,364,955. Polyether urethanes having reactive silane groups can be prepared by various methods. One possibility is to react aliphatic or aromatic diisocyanates in a stoichiometric excess with polyether polyols, which are preferably made up of ethylene oxide and/or propylene oxide, to form isocyanate-containing polyurethane prepolymers which are then reacted with aminosilanes, preferably secondary aminosilanes, to give silane-modified (silane-terminated) polyurethanes. These reactions can be carried out without a tin catalyst (U.S. Pat. No. 6,784,272), by which means it is possible to obtain metal-free silane-modified polyurethanes.

A further possibility is to react aliphatic and aromatic diisocyanates in a substoichiometric amount with polyether polyols, which are preferably made up of ethylene oxide and/or propylene oxide, to form hydroxyl-terminated polyurethane prepolymers which can then be reacted with an isocyanatosilane to give silane-terminated polyurethanes.

A further possibility is to react monools (e.g. α-allyl-ω-hydroxyl polyols) with diisocyanates, preferably aliphatic diisocyanates, to form polyurethane prepolymers having unsaturated end groups. The silane groups can then be introduced via a hydrosilylation reaction with hydrogen silanes such as HSiMe(OMe)₂ or HSi(OMe)₃ in the presence of noble metal catalysts, preferably platinum catalysts. This gives silane-terminated polyurethanes. Furthermore, it is possible to react polyether diols or polyether mixtures with isocyanatosilanes such as gamma- and alpha-isocyanatosilanes, particularly preferably dialkoxy- and trialkoxy-functional gamma- and alpha-isocyanatosilanes.

A further method of preparing silane-modified polyurethanes is the “Bayer variant”. EP 596360 and U.S. Pat. No. 6,599,354 describe the preparation of an acyclic urea derivative from maleic and/or fumaric esters and aminosilanes having primary amino groups by Michael addition. The acyclic urea derivatives prepared in this way are reacted with isocyanate-containing polyurethane prepolymers to give silane-terminated polyurethanes. WO 2004/060953 and US 2004/0122200 state that cyclic urea derivatives containing silane groups are necessary at the ends of the silane-terminated polyurethanes prepared in this way in order to obtain good thermal stability. These are obtained by treatment of the acyclic urea derivatives with heat and acid catalysts.

US 2004/0087752 and WO 1996/34030 describe polydiorganosiloxane urethanes which are prepared by reacting α,ω-hydroxydiorganosiloxanes, diisocyanates and polyether polyols to form hydroxyl-containing polydiorganosiloxane-urethane prepolymers. US 2004/0087752 describes the subsequent reaction with isocyanatosilanes to give silane-modified polydiorganosiloxane urethanes.

In the presence of atmospheric moisture, the silane-modified polyurethanes and polyurethane copolymers described are able to be activated by hydrolysis even at room temperature with elimination of the corresponding leaving group (e.g. alcohol, ketoxime, acetic acid, etc.). This is followed by a condensation reaction to form an Si—O—Si network. An advantage here is that the silane crosslinking does not liberate a gaseous by-product as in the case of the classical urethane crosslinking. Thus, isocyanate-free products can also be formulated largely without risk. It is known that volatile isocyanate monomers are suspected of being hazardous to health. Depending on the content of reactive silane groups and depending on the structure of the binder, long-chain polymers, relatively wide-meshed three-dimensional networks or else highly crosslinked systems are formed. The properties of the uncrosslinked polymers (viscosity, solubilities, etc.) and also the properties of the formulated and crosslinked compositions (mechanical properties such as modulus, tensile strength, elongation, etc., and hardness, curing all through, UV stability, heat resistance, adhesion, etc.) can be varied over wide ranges corresponding to the numerous possible structures of such silane-terminated binders. There is a corresponding wide variety of possible uses of such silane-terminated polyurethanes. They can be used for producing elastomers, sealants, adhesives, elastic adhesives, rigid and flexible foams, a wide variety of coating systems (paints and varnishes), mould-making compositions (e.g. for dental applications), potting compositions (e.g. in the automobile sector) and levelling compositions (e.g. for building applications), floor coverings, etc. These products can be applied in a wide variety of ways, e.g. painting, spraying, casting, pressing, etc.

An extremely broad raw material base is available for the silane-modified polyurethanes described. Short- and long-chain, linear and branched starting materials can be combined with one another to formulate either very soft and stretchable sealants or solid elastic adhesives as in no other technology. The range of applications is correspondingly broad, extending from classical sealing tasks in building and construction, in industry and manual trades via home use to demanding elastic adhesive bonding.

The silane-modified polyurethanes and diorganosiloxane-urethane polymers described have the disadvantage of having an organic polymer skeleton which has to be stabilized against ultraviolet light and weathering influences, e.g. heat, by means of additives such as light stabilizers (e.g. HALS=hindered amine light stabilizer) and antioxidants (e.g. phenolic antioxidants). These stabilizers can have an adverse effect on the properties of the polymers; in addition, their content in the polymer decreases over time as a result of decomposition and sweating-out. The polyurethanes are, inter alia, characterized by their —NH—CO—O— group in the skeleton. All forms of polyurethanes are susceptible to chemical degradation by oxidation, which leads firstly to yellowing and subsequently to loss of the mechanical properties. Chemical degradation of polyurethanes is often accompanied by a sharp, acrid odour. Polyurethane foams tend to decompose more quickly than solid polyurethane bodies since they offer a significantly larger surface area for oxidation reactions. These sometimes also take place during production when air or nitrogen is blown through to form a foam. Oxidation is the most important degradation mechanism, but polyurethanes can also be decomposed by hydrolytic reactions. Hydrolysis leads to loss of the mechanical properties of polyurethanes. In the case of polyurethanes produced on the basis of polyesters, hydrolysis takes place first and foremost as a result of the action of alkalis. This results in hydrolysis of the ester groups. When the ester bridges in the chain are broken, new alcohol and carboxyl groups are formed. The latter have a catalytic effect on further hydrolysis reactions. Polyurethanes based on polyethers are hydrolysed by acids. Thermal decomposition reactions are reinforced further by oxygen and moisture. In general, polyester polyurethanes are more stable than polyether polyurethanes. Light-induced ageing is promoted further by a high atmospheric humidity. Polyurethanes are particularly susceptible in this respect compared to other plastics, since the amino groups present in them are photosensitive. Tertiary amines are often additionally present in the polymer microstructure as a result of the production processes. Photochemical degradation in the presence of oxygen forms hydroperoxides which absorb both in the UV range and in the relatively short wavelength VIS range. The photostability of the polyurethane depends on the components used in its production: thus, polyurethanes derived from aromatic isocyanates are particularly unstable. In addition, polyurethanes are an exception among plastics in respect of microbial attack. Their high nitrogen content makes them attractive to microorganisms.

It is an object of the invention to provide a moisture-curing binder which has good storage stability and after crosslinking/curing has an improved light stability, in particular ultraviolet stability, and weathering stability combined with good physical properties. Furthermore, the binder should be able to be crosslinked swiftly and display good adhesion to various substrates. A further object was to produce an ecologically unproblematical binder having a high degree of consumer acceptance.

### SUMMARY OF THE INVENTION

This object is achieved by a moisture-curing binder which comprises:
(i) a silane-modified polyurethane and
(ii) a silane-modified acrylate polymer.

This binder can cure in the presence of moisture to form a siloxane network.

The invention further provides a kit for producing the moisture-curing binder of the invention, with the kit comprising the above components (i) and (ii) separately from one another, preferably in each case packed in an airtight fashion.

Furthermore, the invention provides a method of producing the moisture-curing binder of the invention, which method comprises mixing the components (i) and (ii).

The invention further provides for the use of the above component (i) and the above component (ii) for producing one-component or two-component elastomers, sealants, adhesives, elastic adhesives, rigid and flexible foams, coating systems such as paints or varnishes, mould-making compositions, potting compositions and levelling compositions, floor coverings, etc.

In addition, the invention provides a moisture-cured binder which can be obtained by curing of the moisture-curing binder of the invention in a moisture-containing atmosphere.

It has surprisingly been found that the thermal stability and the light stability and thus the weathering behaviour of moisture-cured binders based on silane-modified polyurethanes can be improved when a silane-modified acrylate polymer is mixed into the moisture-curing binders. The silane-modified acrylate polymer can crosslink in the presence of moisture both with the silane-modified polyurethane and with itself. At the same time, the binder of the invention after curing has comparably good or improved physical properties compared to conventional binders based on silane-modified polyurethanes alone. A further advantage of the invention is that the components (i) and (ii) are highly compatible with one another and form stable compositions over a wide mixing range.

Mixtures of the components (i) and (ii), preferably in a suitable formulation of the binder obtained in this way, can lead to soft to medium hard, readily curing and weathering-stable compositions or products. In addition, a tacky state similar to that known for solvent-containing pressure sensitive adhesives can be obtained during curing of the binders produced in this way for from 10 to 30 minutes. During this state, two substrates which have been coated with a thin layer of the binder produced in this way can be placed together so that they adhere to one another. They initially adhere only physically to one another. Crosslinking continues to proceed after joining of the parts. After complete curing, the original join can be distinguished neither optically nor mechanically from the remaining adhesive and has good thermal stability. Owing to a certain polarity of the acrylate polymer components, the sealants and adhesives formulated with the binder produced in this way are well suited to the adhesive bonding and sealing of glass. Without fillers and colour-imparting materials, clear and colourless formulations can be produced. These are suitable for applications in which the adhesive join, seal or potting interface at the boundary between two substrates is to be made visually inconspicuous.

The moisture-curing binder of the invention is simple to produce, crosslinks rapidly, has very good storage stability, is resistant to ultraviolet light and weather influences, adheres very well to a wide variety of substrates, leads to low odour pollution during curing, can be formulated using little crosslinking catalyst and thus has excellent development potential for industrial and building applications.

### DETAILED DESCRIPTION OF THE INVENTION

### Preparation of the Silane-Modified Acrylate Polymer

As silane-modified acrylate polymers, it is possible to use silane-modified acrylate copolymers such as block copolymers, grafted copolymers, alternating copolymers or random copolymers into which moisture-reactive silanes such as alkoxysilanes have been copolymerized during their preparation. The preparation of acrylate polymers and also the preparation of silane-modified acrylate polymers is generally known. The polymerization can be carried out free-radically or ionically or by metal catalysis. The free-radical polymerization requires an initiator (e.g. AIBN=azobisisobutyronitrile) and a regulator (e.g. a mercaptan such as a mercaptosilane). The monomers used for the polymerization are usually alkyl acrylates, i.e. alkyl acrylates or alkyl methacrylates, e.g. MMA=methyl methacrylate, nBMA=n-butyl methacrylate or SMA=stearyl methacrylate. As crosslinkers, it is possible to use polyfunctional acrylates such as TMPTMA (=trimethylolpropane trimethacrylate). The crosslinkers are highly reactive, have low volatility and have at least two polymerizable functions in a molecule. The preparation of polymeric binders based on acrylate copolymers, generally known under the name synthetic resin products, is an important application for alkyl acrylates. Acrylic glass occupies a special position and is made virtually exclusively of methyl methacrylate. The softening temperature of copolymers composed of the usual monomers is within the range from −70° C. to +110° C. Long-chain esters as in, for example, SMA lead to wax-like polymer properties. Esters having a branched alcohol radical give polymers having a reduced solution viscosity. Silane-modified acrylate polymers cannot be used alone in, for example, sealant formulations since the resulting products would be too brittle.

Some processes for preparing acrylate polymers, by means of which silane-modified acrylate polymers for use in the present invention can be obtained by copolymerization of a silane, are described below.

Acrylate and methacrylate polymers are preferably prepared so that desired structure-property relationships are obtained. Such polymerization processes are, for example, ionic polymerization and living polymerization. These allow targeted construction of the polymer structures. They make it possible to obtain narrow molecular weight distributions, to determine the type and number of the end groups and, in the preparation of block copolymers, to set the number of blocks, the block length and the block length distribution.

In recent years, numerous new polymerization processes which make the construction of defined molecular structures possible have been developed. Polymerization using metallocene catalysts makes it possible to produce polymers having a narrow molecular weight distribution and a uniform comonomer distribution and makes it possible to control the tacticity and to use novel comonomers. The preparation of block copolymers composed of nonpolar and polar monomers is likewise possible. An example for metal catalyzed polymerization offers the use of Ziegler-Natta catalysts.

Free-radical polymerization is the most widespread process for preparing synthetic polymers. Bulk plastics such as LDPE, PVC and PMMA in particular are produced virtually exclusively by free-radical polymerization. Free-radical polymerization is a chain reaction. Chain initiation, chain growth and chain termination occur in parallel. Initiators used are compounds which, as a result of the introduction of energy, form free radicals, e.g. azo or peroxy compounds. These free radicals react with the monomers and initiate the chains. During chain growth, the free radicals formed at the initiation of the chain add on further monomers in a multiple addition and thus form the polymer chains. The free radicals are highly reactive and react with one another in combination or disproportionation reactions at a diffusion-controlled rate. A further possible reaction is transfer of the active site to, for example, another chain, a monomer, a solvent molecule or a specifically added chain transfer agent, e.g. a mercapto compound such as DS MTMO, DS MTEO, etc. In the ideal case, a Schulz-Flory distribution of 1.5<PMI=polymerization index<2 is obtained.

Living polymerization is defined as a chain reaction without irreversible transfer and termination reactions which leads to defined polymers. The concentration of the active species and the number of polymer chains remain constant during the course of the polymerization. In the ideal case, the molecular weight distribution corresponds to a Poisson distribution. A living polymerization which meets these prerequisites can be carried out anionically and with restrictions cationically or by means of group transfer. Living polymerization requires an increased outlay for the preparation. Since in the living polymerization the chain ends remain active even after complete conversion, block copolymers can be obtained by sequential addition of various monomers and end-functionalized polymers can be obtained by targeted addition of termination reagents. The combination of these processes makes it possible to build up many complicated polymer architectures, e.g. star copolymers, comb copolymers and graft copolymers and also diblock, triblock or multiblock copolymers.

Controlled radical polymerization was developed in the middle of the 1990s and combines the advantages of free-radical polymerization such as large selection of monomers and ease of implementation (e.g. insensitivity toward water and impurities) with the advantages of living ionic polymerization, e.g. narrow molecular weight distributions, formation of complex polymer architectures and introduction of defined end groups.

The concept of controlled radical polymerization is based on an active species and a dormant species. Only the active species is polymerization-active, but the two species are in an equilibrium which is far to the side of the dormant, inactive species. Exchange between the species occurs quickly and reversibly. The consequence is a very low steady-state concentration of free radicals. The termination reactions are suppressed relative to the growth reactions. The number of terminated chains is therefore negligibly small. This controlled (or “living”) radical polymerization thus allows, like living ionic polymerization, control of the course of the polymerization and thus the polymer architecture. The molecular weight distribution therefore corresponds to a Poisson distribution in the ideal case. The most important processes for controlled radical polymerization are ATRP=atom transfer radical polymerization (the most important catalyst system is Cu(I)Cl/bipyridine), SFRP=stable free-radical polymerization and RAFT=reversible addition fragmentation chain transfer process.

ATRP in particular allows the use of many monomers, e.g. also acrylates and methacrylates. The wide range of initiator/catalyst systems makes ATRP very flexible in terms of the choice of reaction conditions, e.g. temperature and solvent. For industrial use, the removal of the copper salts is a cost problem. Colour problems can occur in the use of the products. Furthermore, in steel apparatuses, redox processes can occur between the copper salts and the iron. This is countered by immobilization of the catalyst (e.g. on silica gel, polystyrene, etc.). The use of alternative solvents such as supercritical carbon dioxide or ionic liquids are further proposals. Telechelic polymers are polymers and/or oligomers which have a low molecular weight (Mₙ from about 1000 to 12 000) and two defined, reactive end groups. They make it possible to prepare defined structures such as block copolymers or networks for applications in the surface coatings, adhesives and sealants industry. Telechelic polymers can be prepared by use of suitable initiators, termination reagents or transfer reagents or by chain-analogous reaction. The best-known reactions for preparing telechelic polymers which have a functionality of precisely two are polyaddition (e.g. polyurethanes, polyureas), polycondensation (e.g. polyamide, polycarbonate, polyester) and ring-opening polymerization of heterocyclic monomers (e.g. cyclic esters, carbonates, ethers), if appropriate using termination reagents which contain the desired groups.

In free-radical polymerization, “dead-end” polymerization is used for preparing telechelic polymers. A large excess of an initiator which bears the desired functional group is used for this purpose (e.g. telechelic polymers containing carboxyl or hydroxyl groups). The functionality of two can be achieved when combination of the growing chains represents the only termination reaction (e.g. in the case of styrene, methyl acrylate, etc.). However, this method is unsuitable for monomers such as MMA=methyl methacrylate in the case of which both disproportionations and termination reactions occur. As an alternative, the polymerization can be carried out in the presence of a suitable chain transfer reagent (e.g. CCl₄, CBr₄, CHCl₃, CHBr₃, disulphides, sulphur-containing silanes (e.g. (RO)₃Si—(CH₂)₃—S₂—(CH₂)₃—Si(OR)₃, DS MTMO, DS MTEO, etc.), etc.). In a first step, chains are initiated by means of catalytic amounts of peroxo or azo initiators. The growing chains react randomly with the chain transfer agent with, for example, halogen abstraction and the resulting free radical is again able to start a new chain. This process is referred to as “telomerization”. Telechelic polymers can also be prepared by living ionic polymerization or by means of ATRP. The ATRP which can be employed for preparation of telechelic polymers is based on the reversible exchange of a halogen atom between initiator or growing polymer chain and a catalyst system containing a transition metal (e.g. Cu, Fe, Co, Ru, etc.). This enables free radical concentrations to be kept low and the typical termination reactions of free-radical polymerization thus to be suppressed. Telechelic polymers based on acrylates and methacrylates and having a narrower molecular weight distribution than is possible by means of classical polymerization methods can be prepared by means of ATRP. It is possible to use bifunctional initiators. If the initiator bears two halogen groups (e.g. dichlorotoluene), a halogen-terminated telechelic polymer is formed by monodirectional or bidirectional growth. A large number of functional groups, e.g. alkoxysilane end groups, can be produced from the halogen end groups by chain-analogous reaction.

Silane-modified acrylate polymers which can be used for the present invention are described, for example, in U.S. Pat. No. 4,333,867 and U.S. Pat. No. 1,096,898.

In the preparation of silane-modified acrylate polymers for the present invention, monomers containing silane groups (preferably alkoxysilane groups), e.g. vinylsilanes, acrylsilanes or methacrylsilanes, can be copolymerized with the acrylate monomers by one of the abovementioned processes. The silane-modified acrylate polymer for use in the binders of the invention is obtainable by copolymerization of a silane of the formula (I):

X—(CH₂)ₙ—SiR(OR¹)ₚ(OR³)_{q} (I)

where
X is —CH═CH₂, —O—CO—CHMe═CH₂ or —O—CO—CH═CH₂;
R is a substituted or unsubstituted, linear or cyclic alkyl group, a substituted or unsubstituted aryl or aralkyl group, a substituted or unsubstituted alkoxy group, an oxime group, an acyloxy group or a benzamido group;
R¹ is —(CH₂—CH₂—O)ₘ—R² or —(CH₂—CHR¹—O)ₘ—R²;
R² is H, a substituted or unsubstituted, linear or cyclic alkyl group or a substituted or unsubstituted aryl or aralkyl group;
R³ is a substituted or unsubstituted, linear or cyclic alkyl group or a substituted or unsubstituted aryl or aralkyl group;
n is 0-10, preferably 0, 1 or 3;
m is 1-50, preferably 5-20; and
p and q are each 0, 1 or 2; and p+q=2;

with an acrylate of the formula (II):

CH₂═CR⁴—(CO)—OR⁵ (II),

where
R⁴ is hydrogen, halogen, a substituted or unsubstituted, linear or cyclic alkyl group, a substituted or unsubstituted aryl or aralkyl group, an alkenyl group, a carboxyl group, an acyloxy group, an alkoxycarbonyl group, a nitrile group, pyridyl group, amido group or glycidoxy group; and
R⁵ is hydrogen, halogen, a substituted or unsubstituted, linear or cyclic alkyl group or a substituted or unsubstituted aryl or aralkyl group.

In addition, an olefin of the formula (III):

CH₂═CR⁶R⁷ (III),

where
R⁶ is hydrogen, halogen, a substituted or unsubstituted, linear or cyclic alkyl group or a substituted or unsubstituted aryl or aralkyl group; and
R⁷ is hydrogen, halogen, a substituted or unsubstituted, linear or cyclic alkyl group, a substituted or unsubstituted aryl or aralkyl group, an alkenyl group, a carboxyl group, an acyloxy group, an alkoxycarbonyl group, a nitrile group, a pyridyl group, an amide group or a glycidoxy group,
   can be used in the copolymerization.

The silane-modified acrylate polymer obtained then preferably contains silane groups having one of the following formulae:

—(CH₂)ₙ—SiR(OR¹)ₚ(OR³)_{q} or

—(CO)—O—(CH₂)ₙ—SiR(OR¹)ₚ(OR³)_{q}

in side groups of the polymer backbone and R, R¹, R², R³, n, m, p and q as previously defined.

The substituted or unsubstituted, linear or cyclic alkyl group as the radical R can contain from 1 to 10 carbon atoms, preferably from 1 to 6 carbon atoms. Linear and cyclic alkyl groups, which may be substituted, are preferred for R. Examples of substituents of the linear or cyclic alkyl group are alkyl and alkoxy groups having from 1 to 6 carbon atoms. Multiple substitution is possible. The linear or cyclic alkyl groups are preferably unsubstituted or monosubstituted. Examples of linear alkyl groups are methyl, ethyl, n-propyl, i-propyl, n-butyl, t-butyl, pentyl, hexyl. Examples of cyclic alkyl groups are cyclopropyl, cyclobutyl, cyclopentyl and cyclohexyl.

The aryl group as the radical R can be, for example, phenyl or naphthyl. The aralkyl group is preferably an Ar-C₁₋₆-alkyl group. Possible substituents of the aryl or aralkyl group correspond to those for the linear or cyclic alkyl groups, and these substituents can also substitute the aryl group. The alkoxy group and the acyloxy group can contain from 1 to 10 carbon atoms, preferably from 1 to 6 carbon atoms. Possible substituents on the alkoxy group and the acyloxy group correspond to those for the linear or cyclic alkyl groups.

The substituted or unsubstituted, linear or cyclic alkyl group and the substituted or unsubstituted aryl or aralkyl group as R² and R³ generally correspond to those indicated for the radical R, except that the number of carbon atoms of the substituted or unsubstituted, linear or cyclic alkyl group can be from 1 to 20. Particularly preferred radicals R² are methyl and n-butyl. R³ is particularly preferably methyl.

It is possible to incorporate various silanes of the formula (I) into a silane-modified acrylate polymer. Preferred examples of silanes of the formula (I) are MEMO (3-methacryloxypropyltri-methoxysilane), methyl-MEMO (methacryloxypropylmethyldimethoxysilane), ACMO (acryloxy-propyltrimethoxysilane), VTEO (vinyltriethoxysilane), VTMOEO (vinyltris(2-methoxy-ethoxy)silane). A plurality of different silanes of the formula (I) can be used for the copolymerization.

In the acrylate of the formula (II) and the olefin of the formula (III), the substituted or unsubstituted, linear or cyclic alkyl group or substituted or unsubstituted aryl or aralkyl group R⁴, R⁵, R⁶ and R⁷ independently correspond to those indicated above for R² and R³. The alkenyl groups, acyloxy groups and alkoxycarbonyl groups R⁴, R⁵, R⁶ and R⁷ are independent of one another and can have from 1 to 10, preferably from 1 to 6, carbon atoms. Halogen as R⁴, R⁵, R⁶ and R⁷ can be, in each case independently, fluorine, chlorine, bromine or iodine, with chlorine and fluorine being preferred.

R⁴ is particularly preferably hydrogen or methyl, i.e. the compound of the formula (II) is preferably a (meth)acrylate. R⁵ is particularly preferably methyl, ethyl, propyl, n-butyl, i-butyl, decyl, dodecyl, cyclohexyl, stearyl, benzyl, 2-hydroxyethyl and 2-ethylhexyl.

Examples of acrylates of the formula (II) are acrylic acid, methacrylic acid, acrylonitrile, methyl acrylate, ethyl acrylate, n/iso-butyl acrylate, 2-ethylhexyl acrylate, cyclohexyl acrylate, benzyl acrylate, glycidyl acrylate, stearyl acrylate, methyl methacrylate, n/iso-butyl methacrylate, 2-ethylhexyl methacrylate, 2-hydroxyethyl methacrylate, benzyl methacrylate, stearyl methacrylate, glycidyl methacrylate, acrylamide. These and other acrylates can be selected according to the desired properties of the silane-modified acrylate polymer to be obtained and can be combined with one another.

Examples of olefins of the formula (III) are ethylene, propylene, isoprene, butadiene, chloroprene, vinyl chloride, vinylidene chloride, vinyl acetate, styrene, chlorostyrene, pyridine, 2-methylstyrene, divinylbenzene. These and other olefins can be selected according to the desired properties of the silane-modified acrylate polymer to be obtained and can be combined with one another.

In the copolymerization for preparing the silane-modified acrylate polymer, from 0.1 to 40% by weight, preferably from 0.2 to 20% by weight, particularly preferably from 0.2 to 10% by weight and most preferably from 0.5 to 2% by weight, of silanes of the formula (I) can be used in the monomer mixture and subjected to the copolymerization. The acrylate of the formula (II) and the olefin of the formula (III) together preferably make up at least 60% by weight, particularly preferably at least 80% by weight and most preferably at least 90% by weight, of the mixture for the copolymerization. Acrylate/methacrylate crosslinkers having more than one polymerizable unsaturated bond, e.g. TMPTMA=trimethylolpropane trimethacrylate, can also be added to the monomer mixture.

If an olefin of the formula (III) is used and copolymerized, the proportion of the acrylate of the formula (II) is at least 50% by weight, preferably at least 75% by weight and most preferably at least 85% by weight, based on the total amount of monomers of the formula (II) and monomers of the formula (III).

It is also possible to use generally known regulators for the copolymerization, for example amines (e.g. triethylamine, tripropylamine or tributylamine), halogen compounds (e.g. chloroform, carbon tetrachloride or carbon tetrabromide), mercaptans (e.g. 1-butanethiol, 1-hexanethiol, 1-dodecanethiol, ethyl disulphide, phenyl disulphide or butyl disulphide), alcohols (e.g. ethanol, n-/iso-propanol or n-/iso-/tert-butanol), mercaptosilanes or sulphur silanes (e.g. Si 69, preferably MTMO, MTEO (3-mercaptopropyltriethoxysilane) or methyl-MTMO). These can be used in an amount of from 0.1 to 40% by weight, preferably from 0.2 to 10% by weight, particularly preferably from 0.5 to 5% by weight, in the monomer mixture.

As initiators for the copolymerization, it is possible to use peroxo compounds (e.g. benzoyl peroxide, benzoyl hydroperoxide, di-tert-butyl peroxide, di-tert-butyl hydroperoxide, acetyl peroxide, lauryl peroxide, hydrogen peroxide, persulphuric acid or diisopropyl peroxydicarbonate) and/or azo compounds (e.g. AIBN or substituted AIBN).

The polymerization can be carried out in inert solvents such as diethyl ether, methyl ethyl ether, methyl cellosolve, pentane, hexane, heptane, xylene, benzene, toluene, methyl acetate, ethyl acetate, butyl acetate, etc. The polymerization temperature depends on the initiator used and is preferably in the range from 45° C. to 180° C.

The monomer mixture can be added a little at a time or continuously. This allows the evolution of heat to be controlled. The unsaturated silanes such as α- and γ-MEMO, methyl-MEMO, etc., are incorporated into the acrylate/methacrylate copolymer skeleton and in the presence of moisture act as crosslinking points. The mechanical properties can be controlled via, for example, the monomer mixture, the amount of silane and the other reaction parameters (e.g. amount of regulator).

### Preparation and Properties of the Silane-Modified Polyurethane

Silane-modified polyurethanes suitable for use in the present invention and methods of preparing them are known in the prior art (see introduction). Preferred polyurethanes are ones based on polyalkylene glycol ethers (polyoxyalkylenes) or diorganosiloxanes (preferably dimethylsiloxane) as diol component. Such polyurethanes can be prepared as prepolymers and subsequently be silane-modified. The silane modification generally takes place at the ends of the linear polyurethanes, so that the silane-modified polyurethanes for use in the present invention are preferably silane-terminated polyurethanes. A number of silane-modified polyurethanes and their preparation are described below.

a) Preparation of a Polyurethane Prepolymer Having Terminal Isocyanate Groups and Silane Modification by Means of an Aminosilane or Mercaptosilane

Here, NCO-terminated polyurethane prepolymers are prepared in a first step by using the isocyanate in excess.

The polyurethane prepolymer can be prepared from OH-terminated linear or branched diols or triols (preferably linear diols) with aliphatic or aromatic polyisocyanates (preferably diisocyanates). The polyurethane prepolymer can also be prepared from aliphatic alcohols or OH-terminated linear and/or branched diols or triols with a mixture of aliphatic and/or aromatic monoisocyanates or diisocyanates. This reaction is carried out in the temperature range from 30° C. to 120° C., preferably from 40° C. to 100° C., particularly preferably from 40° C. to 80° C. An NCO/OH equivalence ratio of from 1.1:1 to 3:1, preferably from 1.2:1 to 1.7:1, particularly preferably from 1.3:1 to 1.6:1, can be employed in the reaction. If appropriate, the amine or organometallic catalysts known from polyurethane chemistry (e.g. as described in U.S. Pat. No. 5,554,709, U.S. Pat. No. 4,857,623 and U.S. Pat. No. 6,498,210) can be used in the preparation.

The silane-modified polyurethane can be obtained from the resulting polyurethane prepolymer having isocyanate end groups by reaction with a silane of the formula (IV):

Y-A-SiR′(OR¹¹)ₚ(OR¹³)_{q} (IV)
where
Y is —SH, —NHR¹⁴, —(NH—CH₂—CH₂—)ᵣ—NHR¹⁴;
A is a linear alkylene group which has from 1 to 10 carbon atoms and may be substituted by one or more groups R′;
R′ is a substituted or unsubstituted, linear or cyclic alkyl group, a substituted or unsubstituted aryl or aralkyl group, a substituted or unsubstituted alkoxy group, an oxime group, an acyloxy group or a benzamido group;
R¹¹ is —(CH₂—CH₂—O)ₘ—R¹² or —(CH₂—CHR′—O)ₘ—R¹²;
R¹² is hydrogen, a substituted or unsubstituted, linear or cyclic alkyl group or a substituted or unsubstituted aryl or aralkyl group;
R¹³ is a substituted or unsubstituted, linear or cyclic alkyl group or a substituted or unsubstituted aryl or aralkyl group;
R¹⁴ is hydrogen, a substituted or unsubstituted, linear or cyclic alkyl group, a substituted or unsubstituted aryl or aralkyl group or -A-SiR′(OR¹¹)ₚ(OR¹³)_{q};
m is 1-50, preferably 5-20;
p and q are each 0, 1 or 2; and p+q=2;
r is from 1 to 5, preferably 2.

Here, the group Y can react with a terminal —NCO group, making it possible to obtain, for example, polyurethanes which contain end groups of one of the following formulae:

—NH—CO—S-A-SiR′(OR¹¹)ₚ(OR¹³)_{q}

—NH—CO—NR¹⁴-A-SiR′(OR¹¹)ₚ(OR¹³)_{q}

Unless expressly stated otherwise, the same preferred embodiments as described above in respect of R, R² and R³ apply to the groups defined by the radicals R′, R¹² and R¹³. R¹² is particularly preferably methyl. R¹³ is particularly preferably methyl, ethyl, n-propyl, i-propyl or n-butyl. In the case of the substituted or unsubstituted, linear or cyclic alkyl group or substituted or unsubstituted aryl or aralkyl group R¹⁴, too, the same preferred embodiments as above apply unless expressly stated otherwise. R¹⁴ is most preferably methyl or n-butyl.

As Y, preference is given to secondary amino groups —NHR¹⁴. R¹⁴ is then preferably a substituted or unsubstituted, linear or cyclic alkyl group having from 1 to 20 (preferably from 1 to 10, more preferably from 1 to 6) carbon atoms, a substituted or unsubstituted phenyl or phenylalkyl group or -A-SiR′(OR¹¹)ₚ(OR¹³)_{q}. The phenylalkyl group can be a phenyl-C₁₋₆-alkyl group, preferably a phenyl-C₁₋₃-alkyl group such as benzyl. When R¹⁴ is -A-SiR′(OR¹¹)ₚ(OR¹³)_{q}, then Y is preferably —NHR¹⁴. When the compound of the formula (IV) contains two -A-SiR′(OR¹¹)ₚ(OR¹³)_{q} groups, the radicals defined therein can be identical or different.

Preferred classes of compounds of the formula (IV) in which R¹⁴ is -A-SiR′(OR¹¹)ₚ(OR¹³)_{q} are those in which A is a linear alkylene group having from 1 to 6, particularly preferably from 1 to 3, carbon atoms, e.g. the classes of the formulae HN[—CH₂—CH₂—CH₂— SiR′(OR¹¹)ₚ(OR¹³)_{q})]₂ and HN[—CH₂—SiR′(OR¹¹)ₚ(OR¹³)_{q})]₂. Examples of such compounds are γ- and α-bis-AMMO (AMMO is 3-aminopropyltrimethoxysilane) and bis-AMEO (AMEO is 3-aminopropyltriethoxysilane).

A is preferably —(CH₂—)ₛ— in which s=1 to 10, preferably 1 or 3; or —(CH₂—CHR′—CH₂)—, where R′ is as defined above.

The silane-modified polyurethane is preferably a metal-free silane-modified polyurethane, i.e. the above-described silane modification is preferably carried out in the absence of a metal catalyst in order to avoid traces of metal in the product. Such metal-free silane-modified polyurethanes are comprehensively described in EP 1 245 602. The contents of EP 1 245 602 are hereby incorporated by reference.

In order to be suitable, for example, for sealants, the silane-modified polyurethane should have a molecular weight of from 250 to 60 000, preferably from 300 to 40 000, particularly preferably from 1000 to 30 000. For this purpose, polyether diols prepared, for example, in the KOH process and having a molecular weight of from 1500 to 2000 can be used for the preparation of the NCO-terminated polyurethane prepolymers. However, such prepolymers have relatively high viscosities. The formulation is associated with handling difficulties and should, for example, be compensated for by addition of plasticizer and a relatively low filler content. Another method is the use of high molecular weight polyether diols (Acclaim®) which have a low degree of unsaturation and are prepared, for example, by the metal cyanide process (see U.S. Pat. No. 5,227,434, WO 2004/060953 and DE 19849817). Preference is given to using polyols based on propylene oxide and having molecular weights of from 100 to 20 000, preferably from 500 to 15 000, particularly preferably from 1000 to 12 000. Suitable polyols are, for example, polyoxyalkylene diols (in particular polyoxyethylene, polyoxypropylene and polyoxybutylene), polyoxyalkylene triols, polytetramethylene glycols, polycaprolactone diols and triols and comparable compounds. Further polyols which can be used are, for example, tetraols, pentaols, hexaols, alkoxylated bisphenols or polyphenols, sugars and sugar derivatives (e.g. sorbitol, mannitol, pentaerythritol) and also Poly bd® polymers. For the purposes of the present invention, a polyurethane molecule can contain two or more different diol components. It is also possible to use mixtures of different types of polyurethanes which are based on different diol components.

As isocyanate for preparing the polyurethane prepolymers, it is possible to use aliphatic, cycloaliphatic and/or aromatic diisocyanates of the prior art which preferably have an isocyanate content of from 20 to 60% by weight. Isocyanates which can be used are 2,4-diisocyanato-toluene, its industrial mixtures with, preferably, up to 35% by weight, based on the mixture, of 2,6-diisocyanatotoluene, diphenylmethane 4,4′-diisocyanate, 1-isocyanato-3,3,5-trimethyl-5-isocyanatomethylcyclohexane (IPDI=isophorone diisocyanate), bis(4-isocyanatocyclo-hexyl)methane, 1-isocyanato-1-methyl-4(3)-isocyanatomethylcyclohexane, 1,3-diisocyanato-6-methylcyclohexane, if appropriate in admixture with 1,3-diisocyanato-2-methylcyclohexane. It is of course also possible to use mixtures of the isocyanates mentioned. The numerous liquid diphenylmethane diisocyanates containing 2,4′ and 4,4′ isomers (e.g. Desmodur® N) can also be used. A mixture of diphenylmethane 2,4′- and 4,4′-diisocyanate (MDI), e.g. Monodur® ML, can preferably be used.

b) Preparation of a Polyurethane Prepolymer Having Terminal Hydroxy Groups and Silane Modification by Means of an Isocyanatosilane

Here, OH-terminated polyurethane prepolymers are prepared in a first step by using the isocyanate in a substoichiometric amount. As in process a), the polyurethane prepolymers can be prepared from OH-terminated linear and/or branched diols and/or triols (preferably linear diols) and aliphatic and/or aromatic diisocyanates. The polyurethane prepolymers can also be prepared from aliphatic alcohols such as OH-terminated linear and/or branched diols and/or triols and a mixture of aliphatic and/or aromatic monoisocyanates and diisocyanates. The reaction can be carried out in the temperature range from 30° C. to 120° C., preferably from 40° C. to 100° C., particularly preferably from 50° C. to 80° C. An OH/NCO equivalence ratio of from 1.1:1 to 3:1, preferably from 1.2:1 to 1.7:1 and particularly preferably from 1.3:1 to 1.6:1, should be employed in the reaction. If appropriate, the amine or organometallic catalysts known per se from polyurethane chemistry (e.g. as described in U.S. Pat. No. 4,345,054, WO 2002/068501, WO 2004/060953 and US 2004/0181025) can be used in the preparation.

In a second step, the resulting OH-terminated polyurethane prepolymer is then silane-modified by means of an isocyanatosilane of the formula (V):

OCN-A-SiR′(OR¹¹)ₚ(OR¹³)_{q} (V)

where
A is a linear alkylene group which has from 1 to 10 carbon atoms and may be substituted by one or more groups R;
R′ is a substituted or unsubstituted linear or cyclic alkyl group, a substituted or unsubstituted aryl or aralkyl group, a substituted or unsubstituted alkoxy group, an oxime group, an acyloxy group or a benzamido group;
R¹¹ is —(CH₂—CH₂—O)ₘ—R¹² or —(CH₂—CHR′—O)ₘ—R¹²;
R¹² is hydrogen, a substituted or unsubstituted linear or cyclic alkyl group or a substituted or unsubstituted aryl or aralkyl group;
R¹³ is a substituted or unsubstituted linear or cyclic alkyl group or a substituted or unsubstituted aryl or aralkyl group;
R¹⁴ is hydrogen, a substituted or unsubstituted, linear or cyclic alkyl group, a substituted or unsubstituted aryl or aralkyl group or -A-SiR′(OR¹¹)ₚ(OR¹³)_{q};
m is 1-50, preferably 5-20;
p and q are each 0, 1 or 2; and p+q=2;
r is from 1 to 5, preferably 2.

This makes it possible to obtain silane-modified polyurethanes which have end groups of the following formula:

—O—OC—NH-A-SiR′(OR¹¹)ₚ(OR¹³)_{q}.

Unless expressly stated otherwise, the same preferred embodiments as defined above under a) apply to the radicals R′, R¹² and R¹³. In the case of the substituted or unsubstituted, linear or cyclic alkyl group, too, the same preferred embodiments as above apply.

A is preferably —(CH₂—)ₛ— in which s=1 to 10, preferably 1 or 3; or —(CH₂—CHR′—CH₂)—, where R′ is as defined above.

In order to be suitable, for example, for sealants, the silane-terminated polyurethane should have a molecular weight of from 250 to 60 000, preferably from 300 to 40 000, particularly preferably from 1000 to 30 000. For this purpose, polyether diols prepared, for example, in the KOH process and having a molecular weight of from 1500 to 2000 can be used for the preparation of the NCO-terminated polyurethane prepolymers. However, such prepolymers have relatively high viscosities. The formulation is associated with handling difficulties and should, for example, be compensated for by addition of plasticizer and a relatively low filler content. Another method is the use of high molecular weight polyether diols (Acclaim®) which have a low degree of unsaturation and are prepared, for example, by the metal cyanide process (see U.S. Pat. No. 5,227,434, WO 2004/060953 and DE 19849817). Preference is given to using polyols based on propylene oxide and having molecular weights of from 100 to 20 000, preferably from 500 to 15 000, particularly preferably from 1000 to 12 000. Suitable polyols are, for example, polyoxyalkylene diols (in particular polyoxyethylene, polyoxypropylene and polyoxybutylene), polyoxyalkylene triols, polytetramethylene glycols, polycaprolactone diols and triols and comparable compounds. Further polyols which can be used are, for example, tetraols, pentaols, hexaols, alkoxylated bisphenols or polyphenols, sugars and sugar derivatives (e.g. sorbitol, mannitol, pentaerythritol) and also Poly bd® polymers.

As isocyanate used for preparing the polyurethane prepolymers, it is possible to use those which have been mentioned above for process a).

It is known that α-silanes (e.g. OCN—CH₂—Si(OR)₃) are more reactive than γ-silanes (e.g. OCN—CH₂—CH₂—CH₂—Si(OR)₃) and thus react and crosslink more rapidly. However, the increased reactivity of the alpha-silanes also results in a decreased storage stability (dimer or trimer formation) of the silane and of the silane-modified or silane-terminated polyurethane prepared in this way.

c) Preparation of a Polyurethane Prepolymer Having Terminal Isocyanate Groups with Subsequent Silane Modification According to the “BAYER Variant”.

The preparation of the polyurethane prepolymer having terminal isocyanate groups can be carried out as in process a). Subsequent reaction of the NCO-terminated prepolymers prepared in this way with an acyclic urea derivative, which can be prepared from maleic and/or fumaric esters and aminosilanes having primary amino groups by Michael addition, gives the silane-modified polyurethanes. The “BAYER variant” is described, inter alia, in EP596360 and U.S. Pat. No. 6,599,354. WO 2004/060953 and US 2004/0122200 state that cyclic urea derivatives containing silane groups are necessary at the ends of the silane-terminated polyurethanes prepared in this way to achieve good thermal stability. These can be obtained by treatment of the acyclic urea derivatives with heat and acid catalysts.

As regards the diols and isocyanates for preparing the polyurethane prepolymers, reference is made to what has been said for processes a) and b).

The silane-modified polyurethanes prepared by the methods a) to c) are commercially available as, for example, Desmoseal® LS 2237 (Bayer AG), Polymer ST50 (Hanse Chemie GmbH), Permapol® MS (Courtaulds Coatings Incorporated) or WSP 725-80 (Witton Chemical Company). They complement the silane-terminated polyoxyalkylenes on offer. Suppliers of these are, for example, Kaneka Corporation (MS Polymer® S203H and S303H) and Asahi Glass (Excestar® S2410 and S2420).

d) Preparation of a Silane-Modified Diorganosiloxane-Urethane Polymer

Silicones and polyurethanes complement one another over a wide range. Polyurethanes generally have very good mechanical properties while silicones retain their elasticity, in particular, at low temperatures. In addition, silicones are water-repellent. The reaction of an NCO-terminated polyurethane-silicone prepolymer with aminosilanes is described below.

Polyurethane prepolymers having terminal isocyanate groups can be obtained by reacting an excess of an isocyanate with α,ω⁻-OH-polydiorganosiloxanes. The organic groups in the α,ω-OH-polydiorganosiloxanes are preferably linear alkyl groups having from 1 to 6, preferably from 1 to 3, carbon atoms. Particular preference is given to α,ω-bishydroxypolydimethyl-siloxanes. In addition, it is possible to use polyols. These polyurethane prepolymers can be silane-modified by means of an aminosilane or mercaptosilane, preferably a secondary γ- or α-aminosilane or γ- or α-mercaptosilane.

Polyurethane prepolymers having terminal hydroxy groups can be obtained by reacting a substoichiometric amount of an isocyanate with α,ω⁻-OH-polydiorganosiloxanes. In addition, it is possible to use polyols. These polyurethane prepolymers can be silane-modified by means of an isocyanatosilane, preferably a γ- or α-isocyanatosilane.

These processes are described, for example, in US 2004/0087752 and WO 1995/21206.

### Production of the Moisture-Curing Binders of the Invention

The moisture-curing binders of the invention can be produced by simple physical mixing of a silane-modified polyurethane (i) and a silane-modified acrylate polymer (ii), e.g. on the basis of a solids content of 50% by weight of a silane-modified polyurethane (i) to 50% by weight of a silane-modified acrylate polymer (ii). Mixing ratios of the silane-modified polyurethane (i) to a silane-modified acrylate polymer (ii) of from 99:1% by weight to 1:99% by weight are possible. Preference is given to mixing ratios of from 10:90 to 90:10% by weight, particularly preferably from 20:80 to 90:10% by weight. Mixing ratios of (i) to (ii) of from 65:35 to 90:10% by weight are most preferred.

To reduce the viscosity of the moisture-curing binder, it is possible to add plasticizers, e.g. ones based on Mesamoll®, aliphatic and/or aromatic hydrocarbons, phthalates (e.g. DIUP, DIDP, DIOP, etc.), polyoxyalkylenes, carboxylic esters (e.g. adipic esters, sebacic esters, etc.), etc. Preference is given to adding from 1 to 60% by weight of plasticizer, particularly preferably from 5 to 20% by weight of plasticizer, based on the total mixture. To avoid premature crosslinking by hydrolysis and condensation, it is additionally possible to add water scavengers, e.g. silane-based water scavengers (e.g. VTMO (vinyltrimethoxysilane), VTEO (vinyltriethoxysilane), 6490, Si(OEt)₄, HMDS, etc.), oxide-based water scavengers (e.g. CaO), isocyanate-based water scavengers, etc. Preference is given to adding from 0.1% by weight to 10% by weight of water scavengers, particularly preferably from 0.2% by weight to 1.5% by weight of water scavengers, based on the total mixture of the moisture-curing binder.

One-component and two-component elastomers, sealants, adhesives, elastic adhesives, rigid and flexible foams, a wide variety of coating systems (paints and varnishes), mould-making compositions (e.g. for dental applications), potting compositions (e.g. in the automobile sector) and levelling compositions (e.g. for building applications), floor coverings, etc., can be formulated using the novel binders. These products can be applied in a wide variety of ways, e.g. painting, spraying, casting, pressing, etc. The novel binders are preferably used for producing adhesives and sealants and also elastic adhesives.

Customary further constituents of a formulation of the binder of the invention are solvents, fillers, pigments, plasticizers, stabilizing additives, water scavengers, bonding agents, thixotropes, crosslinking catalysts, tackifiers, etc.

To reduce the viscosity, it is possible to use solvents, e.g. aromatic hydrocarbons (e.g. toluene, xylene, etc.), esters (e.g. ethyl acetate, butyl acetate, amyl acetate, cellosolve acetate, etc.), ketones (e.g. methyl ethyl ketone, methyl isobutyl ketone, diisobutyl ketone, etc.), etc. The solvent can be added during the course of the free-radical polymerization.

The binders of the invention can be formulated with or without fillers. As fillers, it is possible to use both extender fillers and reinforcing fillers. Extender fillers can make up more than 50% by weight of the total formulation. Preference is given to 350 parts by weight of filler per 100 parts by weight of binder, particularly preferably from 50 to 150 parts by weight of filler per 100 parts by weight of binder. Extender fillers and reinforcing fillers, surface-treated and/or not surface-treated, are, for example, natural and precipitated chalks (e.g. Imerseal®, Carbital®, Omyabond®, Omya BLR3, Reverté®, Winnofil®, Socal®, Hubercarb®, Ultra Pflex®, Hi Pflex®, etc.), carbon blacks (e.g. Corax®, Black Pearls®, etc.), silicas (fused and/or precipitated and/or pyrogenic), e.g. Cab-O-Sil®, Aerosil®, etc., aluminium oxide (including pyrogenic aluminium oxide), pyrogenic mixed oxides (e.g. SiO₂/Al₂O₃/Fe₂O₃), glass fibres, aluminium silicates (e.g. kaolin, calcined kaolin, clay, talc, wollastonite, etc.), aluminium hydroxide, magnesium hydroxide, quartz, cristoballite, barium sulphate, glass spheres, zeolites, zinc oxide, nephelinic syenite, layered silicates (e.g. bentonite, clay earth, etc.), feldspar, dolomite, magnesium carbonate, metal powders (e.g. zinc, iron, aluminium, etc.) and comparable fillers. A formulation using pyrogenic oxides (e.g. Aerosil®) can lead to transparent products.

The pigments can be of organic or inorganic origin (e.g. titanium dioxide, including pyrogenic titanium dioxide, effect pigments based on aluminium, e.g. from Eckart or Silberline, azo dyes, etc.). The proportion of pigments in the formulation is preferably from 0 to 80 parts per 100 parts by weight of binder, particularly preferably from 0 to 20 parts by weight.

As plasticizers, e.g. to exert a positive influence on the final properties of the product or to improve the compatibility of the filler with the binder (e.g. in order to achieve higher filler contents), it is possible to use customary phthalates (e.g. Jayflex®, Palatinol®, etc., dibutyl phthalate, diheptyl phthalate, di-2-ethylhexyl phthalate, diisooctyl phthalate, diisodecyl phthalate, diisoundecyl phthalate, etc.), aliphatic dicarboxylic esters (e.g. dioctyl adipate, dioctyl sebacate, etc.), polyalkylene glycol esters (e.g. Bezoflex® 50 and 400, etc., diethylene glycol dibenzoate, triethylene glycol dibenzoate, etc.), chlorinated hydrocarbons, hydrocarbon oils (e.g. alkylbiphenyl, partially hydrogenated terphenyl, etc.), Mesamoll®, Novares®, epoxidized soya oil (e.g. Flexol® EPO) or mixtures thereof. The plasticizer can be added during the course of the free-radical polymerization. To improve the compatibility of filler/plasticizer and to achieve manageable viscosities, dispersants can be used during the process of formulation (e.g. Dispex®, low-viscosity polyacrylates, etc.). The proportion of plasticizer in the formulation is preferably from 5 to 150 parts by weight per 100 parts by weight of binder, particularly preferably from 30 to 100 parts by weight.

Stabilizing additives such as ultraviolet light stabilizers and/or antioxidants can likewise be included in the formulation. From 0 to 30 parts by weight per 100 parts by weight of binder are usual and preferred, with particular preference being given to from 0 to 10 parts by weight. The stabilizing additives can be obtained, for example, from Great Lakes and Ciba Specialty Chemicals under the trade names Anox® 20 and Uvasil® 299 HM/LM or Irganox® 1010 and 1076 and Tinuvin® 327, 213 and 622 LD, etc.

Water scavengers/desiccants can be inorganic oxides such as CaO, etc., zeolites and/or monomeric, oligomeric and/or cooligomeric silanes, e.g. DYNASYLAN®, Silquest®, DYNASIL®, etc. Preference is given to using VTMO, MTMS, 6490 and/or DYNASIL® A. The formulation of storage-stable products without water scavengers/desiccants requires predrying of the fillers and pigments. From 0 to 20 parts by weight per 100 parts by weight of binder are usual and preferred, with particular preference being given to from 0 to 10 parts by weight.

As bonding agents, it is possible to use customary monomeric and oligomeric organosilanes such as DYNASYLAN®, Geniosil®, Silquest® and DYNASIL® (Degussa AG), preferably alpha- and gamma-AMEO, -AMMO, -DAMO, -1411, -TRIAMO, -1505, etc., particularly preferably alpha- and gamma-AMMO, 1146, alpha- and gamma-GLYMO, etc., or mixtures thereof. The bonding agent influences the hardness of the crosslinked product. The formulation can also contain no bonding agent. It is then advisable to apply a primer to the substrate before application of the product. It is also possible to use epoxides, phenolic resins, titanates, zirconates, aromatic polyisocyanates, etc., as bonding agents. From 0 to 20 parts by weight per 100 parts by weight of binder are usual and preferred, with particular preference being given to from 0 to 5 parts by weight.

As thixotropes (“antisagging” agents), it is possible to use microcrystalline polyamide waxes (e.g. Disparlon®, Crayvallac®, Thixatrol®, etc.), silicas (e.g. Aerosil®, Cab-O-Sil®, HDK®, etc.), hydrogenated castor oil (e.g. castor wax from CasChem, Thixcin® from Rheox, etc.), metal soaps (e.g. calcium stearate, aluminium stearate, barium stearate, etc.), surface-treated clays and kaolins, etc. Depending on the fillers used, the formulation can also contain no thixotrope. The proportion of thixotrope in the formulation is preferably from 0 to 50 parts by weight per 100 parts by weight, particularly preferably from 0 to 15 parts by weight.

Crosslinking catalysts are the customary organic tin, lead, mercury and bismuth catalysts, e.g. dibutyltin dilaurate (e.g. from BNT Chemicals GmbH), dibutyltin diacetate, dibutyltin diketonate (e.g. Metatin® 740 from Acima/Rohm+Haas), dibutyltin dimaleate, tin naphthenate, etc. It is also possible to use reaction products of organic tin compounds, e.g. dibutyltin dilaurate, with silicic esters (e.g. DYNASIL® A and 40), as crosslinking catalysts. Titanates (e.g. tetrabutyl titanate, tetrapropyl titanate, etc.), zirconates (e.g. tetrabutyl zirconate, etc.), amines (e.g. butylamine, diethanolamine, octylamine, morpholine, 1,3-diazabicyclo[5.4.6]undec-7-ene (DBU), etc.) or their carboxylic acid salts, low molecular weight polyamides, aminoorganosilanes, sulphonic acid derivatives and mixtures thereof can also be used. The proportion of crosslinking catalyst in the formulation is preferably from 0.01 to 20 parts by weight per 100 parts by weight of binder, particularly preferably from 0.01 to 10 parts by weight.

As tackifiers, it is possible to add, for example, pressure sensitive adhesives. These can be, for example, resin acid esters (rosin, terpentine, etc.), phenolic resins, aromatic hydrocarbon resins, xylene-phenol resins, coumarin resins, petroleum resins, low molecular weight polystyrene, 1,2-polybutadienes having a molecular weight of from about 1000 to 3000, including hydroxy-terminated 1,2-polybutadienes, Polyvest®, Polyoil® LCB 110 and LCB 130, etc. Possible substrates for pressure sensitive adhesives are, for example, tapes, sheets, films, labels, etc. The pressure sensitive adhesive can be applied in situ, as solution (e.g. dispersion, emulsion, etc.), as hot melt, etc., to materials such as paper, woven fabrics, textiles, metal foils, plastic films, glass-reinforced plastics, etc., at room temperature or elevated temperature, e.g. in the presence of water or atmospheric moisture. The proportion of tackifier in the formulation is preferably from 0 to 100 parts by weight per 100 parts by weight of binder, particularly preferably from 0 to 50 parts by weight.

### EXAMPLES

### Example 1

### Silane-Modified Polyurethane by Process a): Polymer 1

### 1. Preparation of the NCO-Polyurethane Prepolymer

69.1 g (0.28 mol) of liquid diphenylmethane 4,4′-diisocyanate and 736.9 g (0.18 mol) of polypropylene glycol having a mean molecular weight of 4000 (NCO/OH ratio: about 1.5) are placed under nitrogen in a 1 l double-walled three-neck flask provided with stirrer, thermometer and reflux condenser. The mixture is heated to 50° C. and 50 ppm of dibutyltin dilaurate (parts by weight based on the total weight) are added as catalyst. The mixture is heated to 75° C. and is maintained at this temperature with stirring until the calculated 0.9% (parts by weight based on the total weight) of free NCO groups have been achieved. The percentage of free NCO groups can be determined, for example, by titration (ASTM D 2572) or IR spectroscopy.

2. Silane Modification by Means of a Secondary γ-aminosilane (e.g. DYNASYLAN® 1189)

45.2 g (0.19 mol) of the secondary g-aminosilane n-butylaminopropyltrimethoxysilane, DYNASYLAN® 1189 (MW=235 g/mol) are added at 75° C. to the NCO-polyurethane prepolymer prepared under 1. The mixture is subsequently cooled to room temperature over a period of 2 hours and the silane-terminated polyurethane (polymer 1) is obtained. The NCO content is 0% (IR spectroscopy).

### Example 2

### Silane-Modified Polyurethane by Process b): Polymer 2

### 1. Preparation of an OH-Terminated Polyurethane Prepolymer

15.6 g (0.07 mol) of liquid isophorone diisocyanate (MW: 222 g/mol) and 500 g (0.06 mol) of polypropylene glycol having a mean molecular weight of 8000 (NCO/OH ratio: about 1.2) are placed under nitrogen in a 1 l double-walled three-neck flask provided with stirrer, thermometer and reflux condenser. The mixture is heated to 50° C. and dibutyltin dilaurate (50 ppm) is added as catalyst. The mixture is heated to 100° C. and maintained at this temperature with stirring for 1 hour. It is subsequently cooled to 60° C.

### 2. Silane Modification Using an α-Isocyanatosilane

24.6 g (0.14 mol) of the □-isocyanatosilane isocyanatomethyltrimethoxysilane (MW: 177 g/mol) are added at 60° C. to the OH-terminated polyurethane prepolymer prepared under 1. and the mixture is stirred at this temperature for 1 hour. The mixture is subsequently cooled to room temperature over a period of 2 hours and the silane-terminated polyurethane (polymer 1) is obtained. The NCO content is 0% (IR spectroscopy).

### Example 3

### Silane-Modified Polyurethane by Process c): Polymer 3

As comparative example, reference may here be made to the product Desmoseal® LS 2237 which is commercially available from Bayer AG.

### Example 4

### Silane-Modified Polyurethane by Process d): Silane-Modified Polydiorganosiloxane Urethane: Polymer 4

### 1. Preparation of an OH-Terminated Polydiorganosiloxane Urethane Prepolymer

42.6 g (0.10 mol) of polypropylene glycol having a mean molecular weight of 425 and 423.6 g (0.21 mol) of α,ω-bishydroxypolydimethylsiloxane having a mean molecular weight of 2000 are placed under nitrogen in a 1 l double-walled three-neck flask provided with stirrer, thermometer and reflux condenser. The mixture is heated to 60° C. and dibutyltin dilaurate (50 ppm) is added as catalyst. The mixture is subsequently heated to 90° C. and 33.4 g (0.15 mol) of liquid isophorone diisocyanate (MW: 222 g/mol) are added dropwise while stirring. After stirring for 2 hours, the mixture is cooled to room temperature and the OH-terminated polydiorganosiloxane urethane is obtained.

### 2. Silane Modification Using a γ-Isocyanatosilane

74.2 g (0.36 mol) of the γ-isocyanatosilane isocyanatopropyltrimethoxysilane (MW: 205 g/mol) are added at 60° C. to the OH-terminated polydiorganosiloxane urethane prepolymer prepared under 1. and the mixture is stirred at this temperature for 2 hours. The mixture is subsequently cooled to room temperature over a period of 2 hours and the silane-terminated polydiorganosiloxane urethane (polymer 4) is obtained.

### Example 5

### Silane-Modified Acrylate Polymer: Polymer 5

256 g (2.0 mol) of n-butyl acrylate (MW: 128 g/mol), 13.3 g (0.13 mol) of methyl methacrylate (MW: 100 g/mol), 68.8 g (0.2 mol) of octadecyl methacrylate (MW: 339 g/mol), 7.0 g (0.03 mol) of DYNASYLAN® MEMO (3-methacryloxypropyltrimethoxysilane, MW: 248 g/mol), 7.4 g (0.04 mol) of DYNASYLAN® MTMO (3-mercaptopropyltrimethoxysilane, MW: 196 g/mol) and 0.5 g of AIBN (α,α′-azobisisobutyronitrile) are mixed at room temperature. 60 g of this mixture are placed under nitrogen in a 1 l double-walled three-neck flask provided with stirrer, dropping funnel and reflux condenser and heated to 70° C. After commencement of the polymerization, the viscosity and the temperature increase. The remainder of the mixture is introduced over a period of 3 hours and the mixture is stirred at 70° C. for another one hour. After cooling to room temperature, a viscous, colourless liquid (about 45 000 mPas) is obtained. The polymerization yield is≧98%.

### Example 6

### Production of Moisture-Curing Binders

The polymers 1, 2, 3 and 4 prepared in Examples 1 to 4 are in each case intimately mixed with the silane-modified acrylate polymer (polymer 5) in a mixing ratio of 70% by weight:30% by weight and 90% by weight:10% by weight for 1 hour at 50° C. with exclusion of moisture and subsequently cooled to room temperature. The compatibility is examined after storage with exclusion of moisture.

| Mixing | Binder: | Appearance after storage | | |
|---|---|---|---|---|
| ratio | Polymers | 1 h/50° C. | 24 h/50° | after 14 d/50° C. |
| 70:30 | 1 + 5 | clear | clear | <10% turbidity |
| 70:30 | 2 + 5 | clear | clear | <10% turbidity |
| 70:30 | 3 + 5 | clear | clear | <10% turbidity |
| 70:30 | 4 + 5 | clear | opaque | about 15% turbidity |
| 90:10 | 1 + 5 | clear | clear | <5% turbidity |
| 90:10 | 2 + 5 | clear | clear | <5% turbidity |
| 90:10 | 3 + 5 | clear | clear | <5% turbidity |
| 90:10 | 4 + 5 | clear | clear | <10% turbidity |

The results show the good compatibility of the polymers 1, 2, 3 and 4 with the acrylate polymer polymer 5. Storage-stable moisture-curing binders are obtained.

### Example 7

### Formulation and Properties of Moisture-Curing Binders

Polymer 3 is intimately mixed with polymer 5 in a ratio of 90% by weight:10% by weight for 1 hour at 50° C. with exclusion of moisture and subsequently cooled to room temperature. 100 parts by weight of this binder mixture together with 100 parts by weight of chalk (Carbital® 110S), 6 parts by weight of pyrogenic silica, 40 parts by weight of plasticizer (DIDP) and a few parts by weight of vinylsilane desiccant (DYNASYLAN® VTMO=vinyltrimethoxysilane) are placed in a planetary mixer (Molteni Labmax®). The mixture is heated to 80° C. and intimately mixed under reduced pressure for 2 hours. The mixture is subsequently cooled to 40° C. and 1.5 parts by weight of aminosilane bonding agent (DYNASYLAN® AMMO=3-aminopropyltrimethoxysilane), 2 parts by weight of vinylsilane desiccant and 0.06 part by weight of crosslinking catalyst (Metatin® 740) are added. The mixture is mixed at 40° C. for 1 hour at atmospheric pressure and subsequently degassed at<5 mm of Hg for 5 minutes. It is subsequently packed in cartridges.

The physical properties of this formulation are determined in accordance with ASTM D 412 and D 624.

| | |
|---|---|
| Tensile strength: | 239 psi = 1.6 MPa |
| Young's modulus: | 198 psi = 1.4 MPa |
| Elongation at break: | 140% |
| Tear propagation resistance: | 22 lbs/in |
| Shore A hardness: | 51 |
| Wet adhesion to aluminium: | 11 lbs/in, 100% cohesion loss |
| Wet adhesion to glass: | 13 lbs/in, 80% cohesion loss |

### Example 8

### Thermal Stability

The silane-modified polymer 1 is intimately mixed with the silane-modified polymer 5 in a ratio of 80% by weight:20% by weight for 1 hour at 50° C. with exclusion of moisture and subsequently cooled to room temperature. The mixture produced in this way and, separately therefrom, the silane-modified polyurethane 1 are then admixed with 1.5 parts by weight of aminosilane bonding agent (DYNASYLAN® AMMO) and 0.06 part by weight of crosslinking catalyst (Metatin® 740) and crosslinked at 23° C. and 50% relative atmospheric humidity for 14 days. The crosslinked binders are stored at 80° C. in a convection drying oven for 1 week and the colour change before and after storage is determined by means of a Minolta Chromameter® CR 300.

Yellowing index of the crosslinked binders (control value: 1.97):

Binder formulation with polymer 1 and polymer 5 (weight ratio=80:20):

| | |
|---|---|
| Before storage: | 2.5 |
| After storage: | 4.9 |

Binder formulation with polymer 1:

| | |
|---|---|
| Before storage: | 4.0 |
| After storage: | 8.6 |

The thermal stability (here yellowing tendency) of the crosslinked binder based on polymer 1 can be improved by addition of polymer 5.

### Example 9

### Ultraviolet Stability

The tensile peeling test was carried out in accordance with ASTM C 794 (“adhesion-in-peel”). The chosen substrate glass was cleaned with isopropanol, detergent and demineralized water and dried in air. Binder 1 is intimately mixed with binder 5 in a ratio of 80% by weight:20% by weight for 1 hour at 50° C. with exclusion of moisture and subsequently cooled to room temperature. The mixture produced in this way and, separately therefrom, polymer 1 are then admixed with 1.5 parts by weight of aminosilane bonding agent (DYNASYLAN® AMMO) and 0.06 part by weight of crosslinking catalyst (Metatin® 740). The formulated binders produced in this way are applied in a thickness of about 1.5 mm to glass by doctor blade and subsequently covered with an aluminium shield (hole size: about 120 μm). Another about 1.5 mm of sealant (binder) are applied to the aluminium shield by doctor blade. The test specimens produced in this way are crosslinked at 23° C. and 50% relative atmospheric humidity for 14 days. The crosslinked test specimens are exposed to ultraviolet light for 350 hours in a QUV oven. Here, the glass side faces the ultraviolet light source. The QUV test was carried out in a cycle of 4 h/60° C./high atmospheric humidity/light on and 4 h/20° C./high atmospheric humidity/light off.

Adhesion of the crosslinked binders after ultraviolet light ageing:

Mixture with polymer 1 and polymer 5 (ratio = 80:20)

| | |
|---|---|
| Dry adhesion before UV ageing: | 39 lbs/in |
| Dry adhesion after UV ageing: | 31 lbs/in |

Mixture with polymer 1

| | |
|---|---|
| Dry adhesion before UV ageing: | 33 lbs/in |
| Dry adhesion after UV ageing: | 15 lbs/in |

The adhesion after ultraviolet light ageing of the crosslinked binder with polymer 1 can be improved by addition of polymer 5.

1. A moisture-curing binder comprising
(i) a silane-modified polyurethane; and
(ii) a silane-modified acrylate polymer; wherein the binder is able to cure in the presence of moisture.

2. The moisture-curing binder according to claim 1, wherein the silane-modified acrylate polymer has a backbone and contains silane groups having at least one of the following formulae:
—(CH₂)ₙ—SiR(OR¹)ₚ(OR³)_{q} or
—(CO)—O—(CH₂)ₙ—SiR(OR¹)ₚ(OR³)_{q}
as side groups of the polymer backbone, wherein
R is a substituted or unsubstituted, linear or cyclic alkyl group, a substituted or unsubstituted aryl or aralkyl group, a substituted or unsubstituted alkoxy group, an oxime group, an acyloxy group or a benzamido group;
R¹ is —(CH₂—CH₂—O)ₘ—R² or —(CH₂—CHR—O)ₘ—R²;
R² is hydrogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
R³ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
n is 0-10;
m is 1-50; and
p and q are each 0, 1 or 2, wherein p+q=2.

3. The moisture-curing binder according to claim 1, wherein the silane-modified polyurethane is a polyurethane which has one or more alkoxysilane end groups.

4. The moisture-curing binder according to claim 1, wherein the silane-modified polyurethane is a silane-modified polyalkylene glycol urethane polymer or a diorganosiloxane urethane polymer.

5. The moisture-curing binder according to claim 1, wherein the silane-modified acrylate polymer is obtained by copolymerizing of a silane of the formula (I):
X—(CH₂)ₙ—SiR(OR¹)ₚ(OR³)_{q} (I)
wherein
X is —CH═CH₂, —O—CO—CHMe═CH₂ or —O—CO—CH═CH₂;
R is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group, a substituted alkoxy group, an unsubstituted alkoxy group, an oxime group, an acyloxy group or a benzamido group;
R¹ is —(CH₂—CH₂—O)ₘ—R² or —(CH₂—CHR—O)ₘ—R²;
R² is hydrogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
R³ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
n is 0-10;
m is 1-10; and
p and q are each 0, 1 or 2; wherein p+q=2;
with an acrylate of the formula (II):
CH₂═CR⁴—CO—OR⁵ (II),
R⁴ is hydrogen, halogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group, an alkenyl group, a carboxyl group, an acyloxy group, an alkoxycarbonyl group, a nitrile group, a pyridyl group, an amido group or a glycidoxy group; and
R⁵ is hydrogen, halogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
and, optionally, with an olefin of the formula (III):
CH₂═CR⁶R⁷ (III),
wherein
R⁶ is hydrogen, a halogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group; and
R⁷ is hydrogen, a halogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group, an alkenyl group, a carboxyl group, an acyloxy group, an alkoxycarbonyl group, a nitrile group, a pyridyl group, an amido group or a glycidoxy group.

6. The moisture-curing binder according to claim 1, wherein the silane-modified polyurethane is obtained by reacting a polyurethane prepolymer having isocyanate end groups with a silane of the formula (IV):
Y-A-SiR′(OR¹¹)ₚ(OR¹³)_{q} (IV)
wherein
Y is —SH, —NHR¹⁴, —(NH—CH₂—CH₂—)ᵣ—NHR¹⁴;
A is a linear alkylene group which has from 1 to 10 carbon atoms and which may optionally be substituted by one or more groups R′;
R′ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group, a substituted alkoxy group, an unsubstituted alkoxy group, an oxime group, an acyloxy group or a benzamido group;
R¹¹ is —(CH₂—CH₂—O)ₘ—R¹² or —(CH₂—CHR′—O)ₘ—R¹²;
R¹² is hydrogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
R¹³ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
R¹⁴ is hydrogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group or -A-SiR′(OR¹¹)ₚ(OR¹³)_{q};
m is 1-50, preferably 5-20;
p and q are each 0, 1 or 2 and p+q=2;
r is from 1 to 5.

7. The moisture-curing binder according to claim 6, wherein R¹⁴ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group having from 1 to 20 carbon atoms, a substituted phenyl group, an unsubstituted phenyl group, a substituted phenylalkyl group, an unsubstituted phenylalkyl group, or -A-SiR′(OR¹¹)ₚ(OR¹³)_{q}.

8. The moisture-curing binder according to claim 1, wherein the silane-modified polyurethane is obtained by reacting a polyurethane prepolymer having hydroxyl end groups with an isocyanatosilane of the formula (V):
OCN-A-SiR′(OR¹¹)ₚ(OR¹³)_{q} (V)
wherein
A is a linear alkylene group which has from 1 to 10 carbon atoms and which may optionally be substituted by one or more groups R′;
R′ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group, a substituted alkoxy group, or an unsubstituted alkoxy group, an oxime group, an acyloxy group or a benzamido group;
R¹¹ is —(CH₂—CH₂—O)ₘ—R¹² or —(CH₂—CHR′—O)ₘ—R¹²;
R¹³ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, or an unsubstituted aralkyl group;
p and q are each 0, 1 or 2 and p+q=2.

9. The moisture-curing binder according to claim 6 wherein A is
—(CH₂—)ₛ— wherein s=1 to 10; or
—(CH₂—CHR′—CH₂)—, whom wherein R′ is a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group, a substituted alkoxy group, or an unsubstituted alkoxy group, an oxime group, an acyloxy group or a benzamido group.

10. The moisture-curing binder according to claim 6, wherein R¹⁴ is a substituted R¹⁴ is hydrogen, a substituted linear alkyl group, an unsubstituted linear alkyl group, a substituted cyclic alkyl group, an unsubstituted cyclic alkyl group, a substituted aryl group, an unsubstituted aryl group, a substituted aralkyl group, an unsubstituted aralkyl group or -A-SiR′(OR¹¹)ₚ(OR¹³)_{q} having from 1 to 20 carbon atoms, a substituted phenyl group, and unsubstituted phenyl group, a substituted phenylalkyl, an unsubstituted phenylalkyl group or -A-SiR′(OR¹¹)ₚ(OR¹³)_{q}.

11. The moisture-curing binder according to claim 7, wherein A is a linear alkylene group having from 1 to 10 carbon atoms.

12. The moisture-curing binder according to claim 1, wherein the silane-modified polyurethane is a metal-free silane-modified polyurethane.

13. The moisture-curing binder according to claim 1, further comprising at least one of solvent, a filler, a pigment, a plasticizer, a stabilizing additive, a water scavenger, a bonding agent, a thixotrope, a crosslinking catalyst, or a tackifier.

14. A kit for producing a moisture-curing binder according to claim 1, said kit comprising said
silane-modified polyurethane and said silane-modified acrylate polymer.

15. A method of producing a moisture-curing binder according to claim 1, comprising mixing said silane-modified polyurethane with said silane modified polyacrylate polymer.

16. A one-component or two-component elastomer, a sealant, an adhesive, an elastic adhesive, a rigid foam, a flexible foam, a coating system, a mold-making composition, a potting composition, a levelling composition or a floor covering comprising the a moisture cured binder produced by curing the moisture-curing binder of claim 1.

17. Moisture-cured binder produced by curing the moisture-curing binder of claim 1 in a moisture-containing atmosphere.
